(19) United States
(12) Patent Application Publication
(10) Pub. No.: US 2003/0050994 A1
(43) Pub. Date: Mar. 13, 2003

(54) Method of aggregating, classifying, reporting and cross-tabbing data in real time

(76) Inventor: Robert Pollack, Longwood, FL (US)

Correspondence Address: KENNETH F. PEARCE, ATTORNEY AT LAW, 631 DENMARK DRIVE, DANVILLE, KY, 40422-2419, US

(21) Appl. No.: 09/917,108

(22) Filed: Jul. 27, 2001

(51) Int. Cl. G06F 15/16

(52) U.S. Cl. 709/217; 709/203; 707/10

(57) ABSTRACT

An end user friendly method of categorizing, aggregating, classifying, reporting and cross-tabbing data, in real time. The unique method interlinks a server with remote interfaces. Templates of the present method propound stimuli at the user. An authorized user can govern the format of the templates from the remote interface. The method can also include the step of classifying the authorized response into at least two sub-classifications.

### BACKGROUND OF THE INVENTION

1. Copyright Notice

A portion of this Application for Letters Patent includes matter subject to Title 17 of the United States Code. The Copyright owner does not object to the reproduction of any matter enabled herein and necessary to practice the present invention that may be contained any subsequent Patent document granted from this Application, after the expiration of such subsequent Letters Patent. However, the Copyright owner reserves all rights flowing from the Copyright of the computer program identified in this Application for Letters Patent.

2. Field of the Invention

The present method can interlink a remote interface and a server. Due to the invention's unique computer program, Microsoft, Apple, PDA and wireless cellular are examples of operating platforms positioned remote from the server which can be interlinked with the server's database and template(s). An important feature of the current invention allows an authorized governor using one the above identified platforms and remote from the server to govern templates displayed by the server on remote interfaces. Thus, an authorized governor can modify an existing template or create a new template in the server's memory. Authorized governors and authorized respondents comprise the group known as authorized users.

In operation, the template generates and propounds stimuli at authorized user's remote platforms. Upon responding to the textual, graphic, pictorial or combined textual/graphic/pictorial stimulus or stimuli, the authorized response or responses is/are categorized, aggregated and classified into the server's database. Very importantly, the authorized responses are categorized, aggregated, classified and sub-classified, in real time.

Other features of the current method provide for the cross-tabbing of data and the time-stamping and dating of all interactions between authorized users and the server's database. The server's memory can be searched according to predetermined paradigms which may be determined by an authorized governor. Additionally, an authorized user can search the database by using textual parameters, such as, key word, question or responses to questions.

3. Description of the Previous Art

a) U.S. Pat. No. 6,084,585-Kraft, et. al., enables a graphical user interface for a computer video display that projects both a menu entry and a data field. After making a selection from the video menu, a user completes at least one row of an entry template that is part of an electronic form. The '585 patent teaches that the electronic form is viewed by the user at an interface remote from the central computer. Upon completion of the electronic form, it is transferred to the central storage computer. Kraft, et. al., indicates that the invention is compatible with a variety of different platforms, including desktops, kiosk stations or portable hand held devices.

b) U.S. Pat. No. 6,182,084 B1-Cockrell, et. al., discloses a data storage, retrieval and comparison system for sporting events as well as a method of use that exemplifies the system. Raw historical statistical data is first incorporated into computer storage. As new data is received, it is converted into first formatted data that is compared against the previously stored historical data. Upon the appropriate condition, the central processor system broadcasts aggregated data to client computers interlinked in a common network with the central processor. A client computer can also request specific information from the central computer.

c) U.S. Pat. No. 5,740,549-Reilly, et. al., teaches an information and advertising distribution system. In other words, the Reilly, et. al., invention is an electronic information distribution system that sends information to the subscriber's computer database. The '549 patent allows the subscriber to select the news and advertising profile of interest to the subscriber. From time to time, the subscriber's computer workstation establishes a communication with the system's information server to update the information and advertisements stored in the workstation's local memory. Reilly, et. al., requires that the information selected by the subscriber be displayed in the screen saver function of the workstation video.

d) U.S. Pat. No. 5,226,177-Nickerson discloses a system for collecting data from respondents. The system includes a central portion with a processor and a base station and a remote portion dedicated to wireless units. A respondent answers the multiple choice questions that are displayed on the wireless unit. Via optic, radio or acoustic links with the remote unit, the central processor accumulates the response data in real time. The '177 patent requires that the central processor sequentially guide respondents through preselected questions or steps. And finally, Nickerson's wireless unit is limited by the range of the radio frequency transceiver from the base unit.

e) U.S. Pat. No. 5,546,455-Joyce, et. al., enables an automatic call distribution system for routing incoming calls used in conjunction with a private switchboard or Private Branch Exchange (PBX). The '455 patent machine code enables a method of analyzing and reporting on live data generated by the client system, in substantial real time, wherein the host server automatically generates executable machine code to execute the user's request, as if the query were directed to a relational database. Due to the execution of the machine code, shared memory results are reported to the requesting client system responsive to the user-specified subset of data.

f) U.S. Pat. No. 5,778,368-Hogan, et. al., describes a Multi-Cross Platform Repository System to fully characterize, evaluate and reuse real time embedded software stored in the repository database. The practice of the Hogan, et. al., Patent utilizes computer desktop servers, security packages, search and display templates, FTP server software, repository storage and software analysis tools.

g) U.S. Pat. No. 5,553,282-Parrish, et. al., discloses a software project history database and method of operation. After logging in, the program developer retrieves a draft of a program configuration from the server. Thereafter, the program developer can retrieve components to assemble the complete source code for a program.

h) U.S. Pat. No. 5,740,035-Cohen, et. al., enables a self-administered survey device for collecting data regarding television or radio media experiences. Survey data stored in the survey devices is uploaded to a centralized data processing unit through wireless transmission of the survey data. The survey device's memory allows a respondent to edit a previously stored answer. In particular, the Cohen, et. al., method enabled by the '035 patent mandates the steps of: providing a centralized data processor; providing a plurality of survey devices to the respondents for entering data; after completion of the survey by the respondents, receiving the survey devices, including the responses, back from the respondents; and thereafter wirelessly transmitting the survey date entered into the survey devices to the centralized data processor.

i) U.S. Pat. No. 6,134,531-Tewitt, et. al., exemplifies a method of polling audience reactions to broadcast and entertainment programming. The polling results are time-stamped and synchronized in real time. The '531 patent's server computer transmits a web page to the client's computer soliciting user feedback. Tewitt's server's web page is downloaded into the client computer's browser, and the user enters a response that is time-stamped and transmitted to the server computer. Thereafter, the user's time-stamped response is compared and analyzed against the segment of the broadcast program corresponding to the time-stamped response.

j) U.S. Pat. No. 4,531,186-Knapman teaches a method of accessing a database. The user-friendly method utility provides for an unskilled user to access data in bulk storage via a programmed communication block. Data base descriptions and program communication blocks construct a data directory that further displays a menu entry path to the user. Upon user query, the Knapman method evaluates all possible access paths and selects the best.

k) U.S. Pat. No. 5,999,192-Selfridge, et. al., enables a business data exploration and analysis apparatus for discovering useful patterns of data in the database and for interactively specifying one or more operations on business data stored in the relational database. The '192 patent's apparatus displays acyclical directed graphs including nodes for viewing by the business data analyst.

l) U.S. Pat. No. 5,361,200-Weybright, et. al., describes a real time data collection system that requires respondents to use alphanumeric keypads to record their responses to a series of questions. Weybright keypad's numeric answers are communicated and stored in the memory of an intelligent junction box. Thereafter, the '200 patent's numeric answers are communicated from the intelligent junction box to a central computer for statistical analysis.

### SUMMARY OF THE INVENTION

Unlike previous computer methods for collecting data, the present invention provides for the governing of digital templates that stimulate the generation of data from platforms remote from the server. Due to the unique computer program controlling interrelation between the server and remote platforms, the server and the platforms remote from the server can be interlinked via currently available methods for Microsoft, Apple, PDA and/or wireless cellular operating systems.

Categories of data to be aggregated, classified and cross-tabbed by the present invention are agreed upon by the authorized governor and the system administrator or invention's owner. Illustrative examples of categories include agriculture, business, exports, imports, manufacturing, medicine and sales, to name but a few of the voluminous possibilities. Depending upon the preselected parameters, the categorized data can be classified, aggregated, cross-tabbed and/or sub-classified as required by the authorized governor.

Within the ambit of the present invention, authorized users include authorized governors and authorized respondents. Authorized governors can modify or create formats of digital templates from their remote interfaces, whereas authorized respondents can only access report or response digital templates created or modified by authorized governors. An authorized governor can also be an authorized respondent, if an authorized governor is utilizing the report or response digital templates. And still within the scope of the present invention, the system's administrator can also customize the database to generate a report specific to the parameters preselected by the authorized governor.

An object of the present invention is to provide a method of categorizing, aggregating, classifying, cross-tabbing and reporting data in real time.

It is another object of the present invention to enable the governing of the format of a digital template from a platform or interface remote from the server.

Still another object of the present invention is to provide a method compatible with Microsoft, Apple, PDA or wireless cellular platforms.

Yet another object of the present invention is to provide digital templates capable of generating textual, graphic, pictorial stimuli or various combinations thereof and displaying the stimuli on remote interfaces.

Still another object of the present invention is to sub-classify the classifications of data.

It is yet another object of the present invention to prohibit unauthorized use of the server.

Yet still another object of the present invention is to provide a method insuring that a stimulus displayed on the remote interface is not retained at the remote interface.

It is yet another object of the present invention to provide a method of allowing an authorized governor or authorized respondent to search the database according to a pre-selected paradigm.

Still another object of the present invention is to generate statistical data.

Yet another object of the present invention is to generate weighted averages for the data.

It is still another object of the present invention is to allow an authorized user to search the database by specific date or time period parameters.

Still another object of the present invention is to allow an authorized user to search the database by key word, textual question, response to textual question, category, classification and/or sub-classification parameters.

Yet still another object of the present invention is to allow an authorized user to cross-tab from one digital template to another digital template.

An embodiment of the present method can be described as a method of aggregating, classifying and reporting data, in real time, comprising the steps of: generating a digital template for a server including a database for aggregating and classifying the data; via a preprogrammed computer code, controlling the intercommunication between the digital template and the database; prohibiting unauthorized use of and/or authorizing use the server; governing the format of the digital template from a location remote from the server; interlinking the remote interface with the server; displaying the digital template for use by the authorized user; propounding a stimulus from the digital template at an authorized user using the remote interface; aggregating continuously, in real time, the response from the authorized user into said database; classifying continuously, pursuant to an administratively predetermined category the response into said database; sub-classifying the response into at least two categories; and time-stamping and date-stamping the response.

Another embodiment of the present method can be described as an end user friendly method of categorizing, aggregating, classifying and reporting data, in real time, comprising the steps of: generating a plurality of digital templates for a server including a database for aggregating and classifying the digital templates and the data; via a preprogrammed computer code, controlling intercommunication between the digital templates and the database; prohibiting unauthorized use and/or authorizing use of the server; governing the format of at least one of the digital templates from a location remote from the server; interlinking a remote interface with the server, displaying at least one of the digital templates for the authorized user; propounding a stimulus from one of the digital templates at an authorized user using the remote interface; aggregating continuously, in real time, the response into the database; classifying continuously, pursuant to an administratively predetermined category, the response into said database; time-stamping and date stamping the response; and reporting a pre-selected category of real time data to the authorized user.

Yet another embodiment of the present invention can be described as a method of aggregating, classifying and reporting data, in real time, comprising the steps of: generating a plurality of digital templates for a server including a database for aggregating and classifying the digital templates and the data; via a preprogrammed computer code, controlling intercommunication between the digital templates and the database; prohibiting unauthorized use and/or authorizing use of the server; governing the format of at least one of the digital templates from a location remote from the server; selling authorization to the authorized user prior to utilization of the server by the authorized user; interlinking a remote interface with the server; displaying at least one of the digital templates for use by the authorized user; propounding a stimulus from at least one of the digital templates at an authorized user using the remote interface; insuring the stimulus is not retained at said remote interface; aggregating continuously, in real time, the response into the database; classifying continuously, pursuant to an administratively predetermined category, the response into the database; sub-classifying the response into at least two categories; and time-stamping and date stamping the response.

It is the novel and unique interaction of these simple elements which creates the methods, within the ambit of the present invention. Pursuant to Title 35 of the United States Code, descriptions of preferred embodiments follow. However, it is to be understood that the best mode descriptions do not limit the scope of the present invention.

### BRIEF DESCRIPTION OF THE DRAWINGS

FIG. 1 is pictorial of a PC, a PDA and a server.

FIG. 2 is a representation of the server's memory.

FIG. 3 is representation of a template in accordance with the present invention.

FIG. 4 is pictorial representation of authorized users remote from the server.

FIG. 5 is a depiction of another template, within the scope of the present invention.

FIG. 6 is an illustration of the steps of an embodiment of the present method.

FIG. 7 is a depiction of the steps of another embodiment of the present invention.

FIG. 8 is an exemplification of the steps of yet another embodiment of the current method.

FIG. 9 is a diagrammatic representation of the steps of still another embodiment of the present invention.

FIG. 10 is a schema of the steps of yet still another embodiment of the present method.

FIG. 11 is a depiction of the steps of another embodiment of the present method.

FIG. 12 is an illustration of the steps of another embodiment of the present method.

### DESCRIPTION OF THE PREFERRED EMBODIMENTS

Although the disclosure hereof is detailed to enable those skilled in the art to practice the invention, the embodiments published herein merely exemplify the present invention.

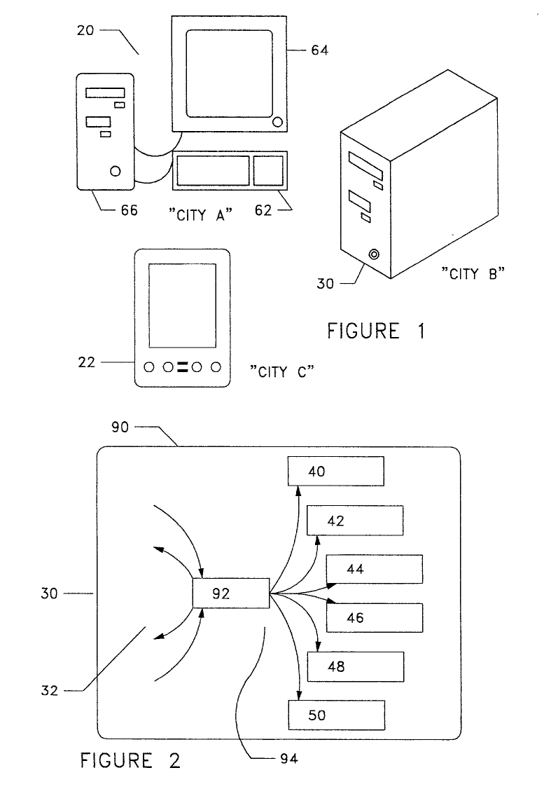

FIG. 1 is a representation of server or server memory (30) and a personal computer (20) and a hand held PDA (22). Personal computer (20) is located in City A; server (30) is found in City B; and PDA (22) is situated in City C. Although personal computer (20) and PDA (22) are different platforms and remote from server (30), each can be interlinked to server (30) by way of the Internet or World Wide Web.

Server memory (32) of server (30) is depicted in FIG. 2. Among other things, server memory (32) includes a plurality of digital templates (40), (42), (44), (46), (48) and (50), authorized governor/respondent entry component (92) and database (90). Those skilled in the art understand that server memory (32) can include more than or less than six interactive templates, as well as more than one database. Additionally, IBM® or other comparable servers can be used to practice the present invention.

Authorized governor/respondent component (92) prohibits unauthorized access. In a similar vein, system administrator or invention owner programs authorized user component (92) to identify and monitor authorized governors/respondents access to server memory (30). Database (90) of memory (30) categories, aggregates and classifies and allows for cross-tabbing of authorized data input, in real time. In accordance with preselected parameters determined by an authorized governor, select embodiments can propound real time weighted averages and/or real time numerically weighted and aggregated responses to questions from server (30) to authorized users of remote platforms (20) and (22).

Categories can be exemplified by company (X), company (Y), company (Z), government department (D), elephant trainers (E), golf association (G), teachers' association (T), milk chocolate manufacturers (M), hospital (H), franchise (F), to propose but a few of the plethora of categories. An example of a classification, within a category, is a specific restaurant, identified by number and location, e.g. a particular franchisee of a national franchise at a specific location. Sub-classifications of the classified category for the fast-food franchisee could be exemplified by quality of service and food quality.

Within the scope of the present invention, when using the search and/or select field features or steps of the present method, an authorized user can cross-tab from one classification to another classification, one sub-classification to another classification, or view the total aggregated report for the results for a specific question which can also include the aggregated weighted responses to the specific question, e.g., a Likert scale question and its corresponding weighted responses. By way of additional illustration, for a fast-food franchise having a multitude of franchisees, an authorized user of the franchisor can cross-tab from one store's data to another store's data. Moreover, the franchisor can view real time data for all franchisees, or for a select group of franchises, as well as by each individual franchisee.

Returning to FIG. 2, computer program (94) controls intercommunication between templates (40), (42), (44), (46), (48), (50) and database (90) and authorized user entry (92). Typically, prior to practicing the present invention, an authorized user will purchase authorized entry/access into server memory (32). At the time of purchasing entry, the system administrator or invention owner will issue the authorized governors and authorized respondents personal identification numbers or passwords or both that allow the authorized users electronic entry/access into server (30). Personal identification numbers can also allow the present method to monitor authorized users access/input, for example, by time and date-stamping all authorized access of server (30). As used in this Application for Letters Patent, an authorized governor can modify or create digital templates as well as view data or respond to the stimulus generated by digital templates, while an authorized respondent can only view data or respond to the stimulus generated by digital templates.

As set forth in FIG. 1, remote interface (22) is a Palm Pilot VIIx incorporating the Palm operating system. Thus, those skilled in the art understand that the present invention is functional, when using a wireless remote interface. However, as also shown in FIG. 1, those skilled in the art recognize that other interfaces remote from server (30) used to practice the present invention can be configured with operating platforms supplied by IBM®, Microsoft®, Apple®, or any other currently available PC operating system that includes a web browser. In other words, the present method is compatible with an IBM® PC, a Palm® Pilot, an Apple® Macintosh®, or digital cellular interface remote from server (30).

With reference to FIGS. 1 and 2, computer program (94) interlinks and interrelates remote interface (20), authorized user entry (92), templates (40), (42), (44), (46), (48) and (50) and database (90) using either wired or wireless, intranet or Internet connections. Remote interface (20) includes keypad (62) for data entry, video display (64) and processor (66). Depending upon the preselected paradigm for a particular authorized user, after the authorized user has logged into server (30), the authorized user can view any, some or all of the digital templates (40), (42), (44), (46), (48) and (50) of database (90) of server memory (32). Templates (40), (42), (44), (46), (48) or (50) can be displayed, serially, alternating or concurrently, on video display (64).

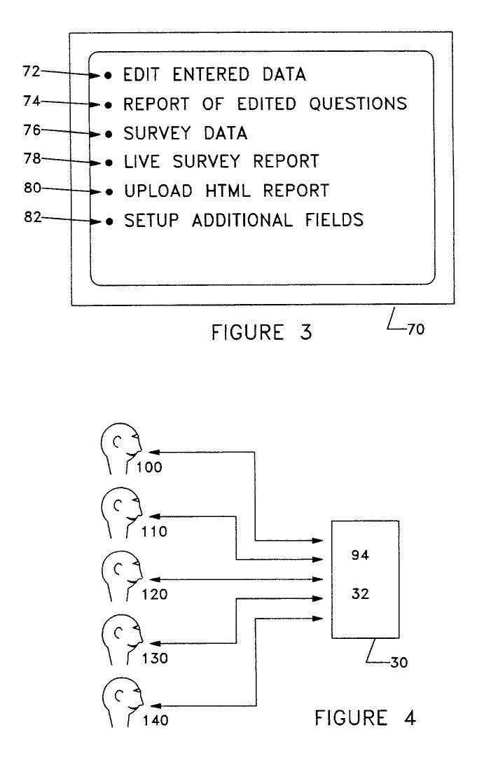

By way of example and turning to FIG. 3, after logging into 24/7 Franchised Restaurants, from server memory (32), an authorized governor of 24/7 Franchised Restaurants, among other stimuli, could view data entry fields (70) of a template propounded on video display (64). Illustrative data entry fields (70) include:

(72) Edit Entered Data

(74) Report Of Edited Questions

(76) Survey Data

(78) Live Survey Report

(80) Upload HTML Report

(82) Setup Additional Fields

Within the ambit of the current method, any stimulus can be textual, graphic, pictorial, or any combination thereof. As shown, stimulus (70) is highlighted text. Those skilled in the art will recognize, the authorized governor can respond to stimulus by using the keypad (62) or mouse (not shown) functions of remote interface (20).

Due to entry/access component (92), only an authorized governor will be able to utilize the modify/create new template or new format for template functions of the present invention. For security reasons, computer program (94) insures authorized users only have access to pre-selected categories, classifications and sub-classifications of database (90). By way of illustration, representatives of company (X) are not allowed access to company (Y's) templates or data, and vice versa. And in a similar vein, some authorized governors of company (X) may have a more limited capability of modifying the templates of company (X') database's categories than other governors. For example, company (X's) chief operating officer could have unlimited modifying capabilities while a middle level manager could be limited to only modifying select templates.

The present invention can report, classify and sub-classify as well as provide for the cross-tabbing of data from virtually any preselected category. However, for ease of understanding, simplified embodiments demonstrating a practice of steps of the present method will be set forth in the Specimens below. The Specimens that follow are directed toward data for a hypothetical 24/7 Franchised Restaurant No. 3333, but in no way are to be construed to limit the scope of the present invention to statistical data aggregations for restaurants. Those skilled in the art will discern the categorization, classification, sub-classification, aggregation, modification, cross-tabbing and reporting steps of the current method can be easily practiced in more complex arenas, such as, a trauma center hospital and the resultant data generated by and between the hospital and the multitude of physicians and staff associated with the hospital.

With a view toward the Specimens, Franchisor purchases the category 24/7 Franchised Restaurants from system administrator. 24/7 Franchised Restaurants has a total of 5000 restaurants in North America. Depending upon the predetermined parameters of Franchisor, the Franchisor can utilize as many different templates of server memory (32) as needed.

As portrayed in FIG. 4, stimuli propounded by computer program (94) and server memory (32) and flowing from the 24/7 Franchised Restaurants report data and/or solicit responses from authorized governor (100-district manager of area 66 for 24/7 Franchised Restaurants), authorized respondent (110-customer of 24/7 Franchised Restaurants No. 3333), authorized respondent (120-graveyard shift manager of 24/7 Franchised Restaurants No. 3333), authorized respondent (130-store manager of 24/7 Franchised Restaurants No. 3333) and authorized respondent (140-customer of 24/7 Franchised Restaurants No. 3333).

Responses from remote interfaces (20) for authorized users are imparted to server (30), via an intranet or Internet connection, and the responses are continuously aggregated, classified and sub-classified, in real time. However, by utilizing the search by date and time frame step, an authorized user can view aggregated data for a previous time period. Importantly and still within the scope of the present invention, an authorized user may also be allowed to edit prior responses to correct the erroneous earlier responses. To preserve the integrity of the data, entry/access (92) of database (90) insures such corrections are time and date-stamped.

Computer program (94) categorizes, aggregates, classifies, sub-classifies, and provides for modifying/creating cross-tabbing and weighted averaging of the data, in real time. Further, it has been unexpectedly discovered that the present method can accomplish these steps in under two seconds. And still in accordance with the present method, using their respective remote interfaces (20), any, some or all of authorized users (100), (110), (120), (130) and (140) can access server memory (32) separately, serially or concurrently.

In Specimen No. 1, at 0300, of day 111, of operating period of 24/7 Franchised Restaurant No. 3333, an authorized user (110) at a table is propounded by the following template.

Specimen No. 1

| | |
|---|---|
| Host/Hostess | |
| Were you greeted in a friendly manner? | Yes/No |
| Were you seated on time? | Yes/No |
| Were you satisfied from the time | Select Range (1-5) |
| you were greeted until you were seated? | |
| Food Quality | |
| Were hot items served hot? | Yes/No |
| Were cold items served cold? | Yes/No |
| Did you receive your food as ordered? | Yes/No |
| How satisfied were you with the quality of your | Select Range (1-5) |
| food? | |
| Dining Experience | |
| How satisfied were your with the overall dining | Select Range (1-5) |
| experience? | |
| How likely are you to dine here again? | Select Range (1-5) |

Computer program (94) converts and server memory (32) reports responses to “Yes/No” stimuli as: 100.00% for yes and 0.00% for no. In this specific embodiment, the “Select Range (1-5)” stimuli are Likert scales. As scaled, in these Specimens, 1 is the most likely or highest value while 5 is the least likely or lowest value. However, those skilled in the art comprehend other weighted scales can also be utilized. In one embodiment of present invention, computer program (94) converts and server memory (32) reports the Likert scales as: 1=100.00%, 2=75.00%, 3=50.00%, 4=s 25.00% and 5=00.00%. The current method also allows an authorized governor to select scale values other than percentages, e.g., 1, 3, 6, 9, etc. In other words, an authorized governor can select scale values in accordance with a predetermined paradigm. Importantly and as set forth in Specimens 2-6, below, to preserve the “weighted average” construct, there is a choice of “N/A” so that null responses do not adversely effect the integrity of the weighted average.

As shown in Specimen No. 2, at some time during the graveyard shift of day 111 of the operating period, authorized respondent (120), the graveyard shift manager of 24/7 Franchised Restaurant No. 3333, is stimulated by the following template.

Specimen No. 2

| | Avg. | No. Valid |
|---|---|---|
| | Response | Responses |
| Host/Hostess | | |
| Were you greeted in a friendly manner? | 100.00% | 10 |
| Were you seated on time? | 100.00% | 10 |
| Were you satisfied from the time you were | 100.00% | 10 |
| greeted until you were seated? | | |
| Food Quality | | |
| Were hot items served hot? | 90.00% | 9 |
| Were cold items served cold? | 00.00% | |
| Did you receive your food as ordered? | 100.00% | 10 |
| How satisfied were you with the quality of your | 75.00% | 10 |
| food? | | |
| Dining Experience | | |
| How satisfied were your with the overall dining | 90.00% | 9 |
| experience? | | |
| How likely are you to dine here again? | 100.00% | 9 |
| Weighted Average | 83.88% | |

As shown in Specimen No. 3, at some time during day 111 of the operating period, authorized respondent (130), the store manager of 24/7 Franchised Restaurant No. 3333, is stimulated by the following template.

Specimen No. 3

| | Avg. | No. Valid |
|---|---|---|
| | Response | Responses |
| Host/Hostess | | |
| Were you greeted in a friendly manner? | 95.00% | 20 |
| Were you seated on time? | 100.00% | 21 |
| Were you satisfied from the time you were | 100.00% | 18 |
| greeted until you were seated? | | |
| Food Quality | | |
| Were hot items served hot? | 95.00% | 20 |
| Were cold items served cold? | 100.00% | 1 |
| Did you receive your food as ordered? | 100.00% | 21 |
| How satisfied were you with the quality of your | 90.00% | 21 |
| food? | | |
| Dining Experience | | |
| How satisfied were your with the overall dining | 87.00% | 18 |
| experience? | | |
| How likely are you to dine here again? | 95.00% | 18 |
| Weighted Average | 95.77% | |

As shown in Specimen No. 5, at the end of day 111 of the operating period, authorized respondent (130), the store manager of 24/7 Franchised Restaurant No. 3333, is stimulated by the following template.

Specimen No. 5

| | Avg. | No. Valid |
|---|---|---|
| | Response | Responses |
| Host/Hostess | | |
| Were you greeted in a friendly manner? | 84.00% | 270 |
| Were you seated on time? | 90.00% | 270 |
| Were you satisfied from the time you were | 96.00% | 240 |
| greeted until you were seated? | | |
| Food Quality | | |
| Were hot items served hot? | 93.00% | 240 |
| Were cold items served cold? | 81.00% | 330 |
| Did you receive your food as ordered? | 90.00% | 570 |
| How satisfied were you with the quality of your | 96.00% | 510 |
| food? | | |
| Dining Experience | | |
| How satisfied were your with the overall dining | 96.00% | 540 |
| experience? | | |
| How likely are you to dine here again? | 90.00% | 570 |
| Weighted Average | 90.67% | |

As shown in Specimen No. 6, for the 30 days prior to day 111 of the operating period, authorized governor (100), the district manager of area 66 of 24/7 Franchised Restaurants, is stimulated by the following template.

Specimen No. 6

| | Avg. | No. Valid |
|---|---|---|
| | Response | Responses |
| Host/Hostess | | |
| Were you greeted in a friendly manner? | 78.00% | 8100 |
| Were you seated on time? | 90.00% | 8900 |
| Were you satisfied from the time you were | 87.00% | 8000 |
| greeted until you were seated? | | |
| Food Quality | | |
| Were hot items served hot? | 96.00% | 12400 |
| Were cold items served cold? | 93.00% | 18900 |
| Did you receive your food as ordered? | 96.00% | 31300 |
| How satisfied were you with the quality of your | 87.00% | 30600 |
| food? | | |
| Dining Experience | | |
| How satisfied were your with the overall dining | 81.00% | 29700 |
| experience? | | |
| How likely are you to dine here again? | 84.00% | 30300 |
| Weighted Average | 88.00% | |

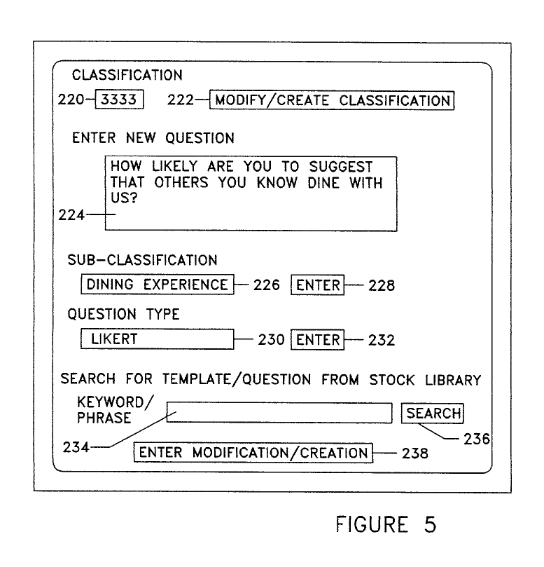

After reviewing Specimen No. 6's propounded template, authorized governor (100) of area 66 for 24/7 Franchised Restaurants decides to modify the customer satisfaction template located in server memory (32) for 24/7 Franchised Restaurant No. 3333 such that the new template will be available for propounding on day 112 of operating period. From an interface (20) remote from server (30), district manager modifies the format of the “Dining Experience” sub-classification template to include the new question, “How likely are you to suggest that others you know dine with us?” After logging into server memory (32), authorized governor (100) will be propounded by a template, as illustrated in FIG. 5.

Stimuli propounded in FIG. 5 include a classification field (220), a modify/create classification field (222), an enter new question field (224), a sub-classification field (226) and its corresponding enter field (228), a question type field (230) and its corresponding enter field (232), a search for template/question field (234) and its corresponding search field (236) and an entry modification/creation field (238). Although authorized governor (100) selected to modify only the 24/7 Franchised Restaurant No. 3333 template, the authorized governor (100) could have just as easily modified the templates for all 24/7 Franchised Restaurants in area 66. Alternatively, authorized governor could have created an entirely new template for 24/7 Franchised Restaurants. Importantly, the modification/creation steps could also be practiced using a remote interface (22), i.e., the Palm Pilot VIIx, thereby insuring that no data from server memory (32) is retained in remote interface (22).

In Specimen No. 7, on day 112, of operating period of 24/7 Franchised Restaurant No. 3333, an authorized user (140) at a table is propounded by the following template.

Specimen No. 7

| | |
|---|---|
| Host/Hostess | |
| Were you greeted in a friendly manner? | Yes/No |
| Were you seated on time? | Yes/No |
| Were you satisfied from the time | Select Range (1-5) |
| you were greeted until you were seated? | |
| Food Quality | |
| Were hot items served hot? | Yes/No |
| Were cold items served cold? | Yes/No |
| Did you receive your food as ordered? | Yes/No |
| How satisfied were you with the quality of your | Select Range (1-5) |
| food? | |
| Dining Experience | |
| How satisfied were your with the overall dining | Select Range (1-5) |
| experience? | |
| How likely are you to dine here again? | Select Range (1-5) |
| How likely are you to suggest that others you | Select Range (1-5) |
| know dine with us? | |

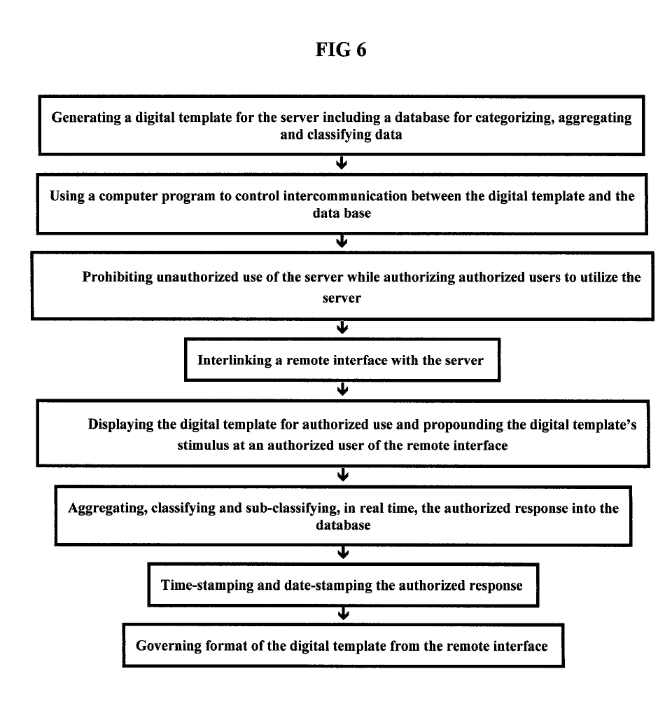

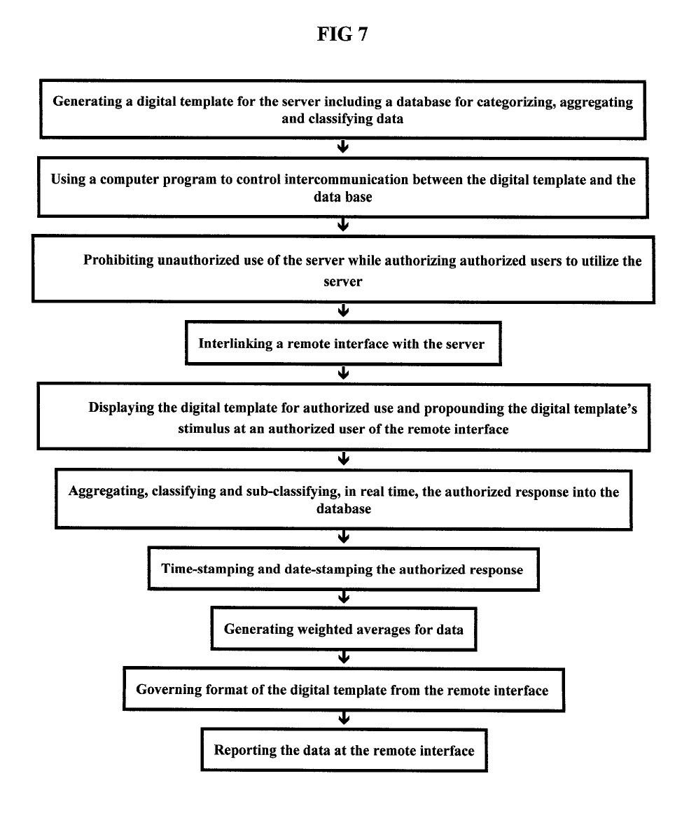

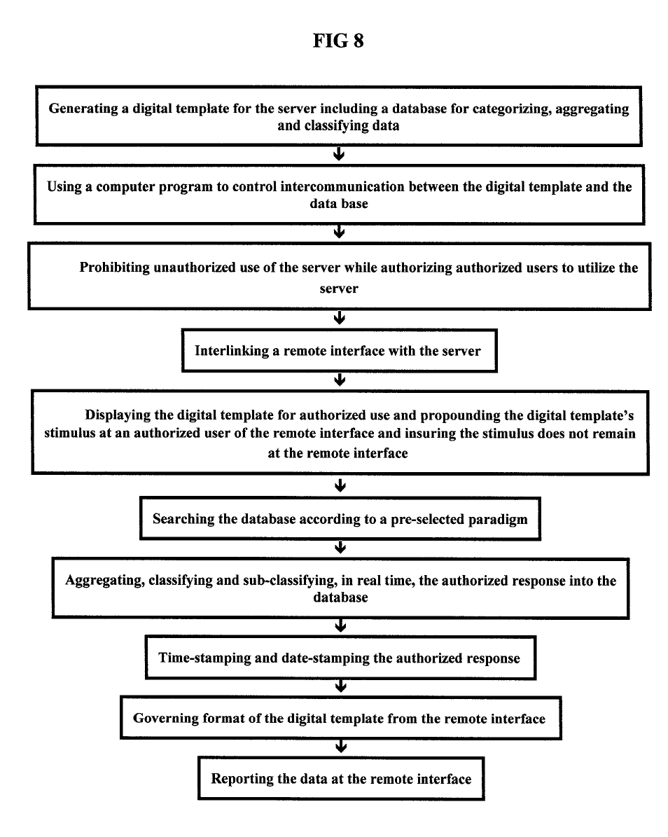

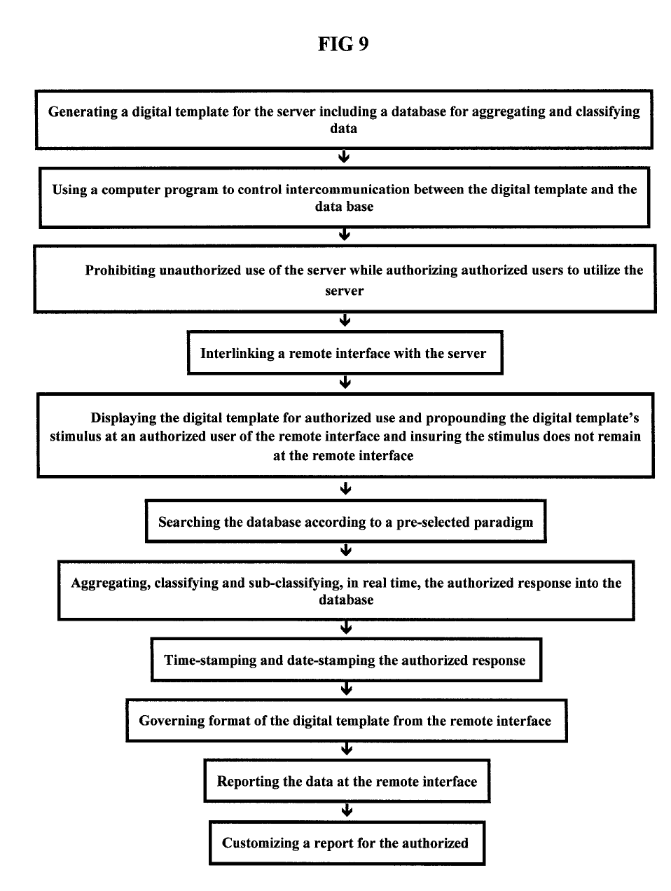

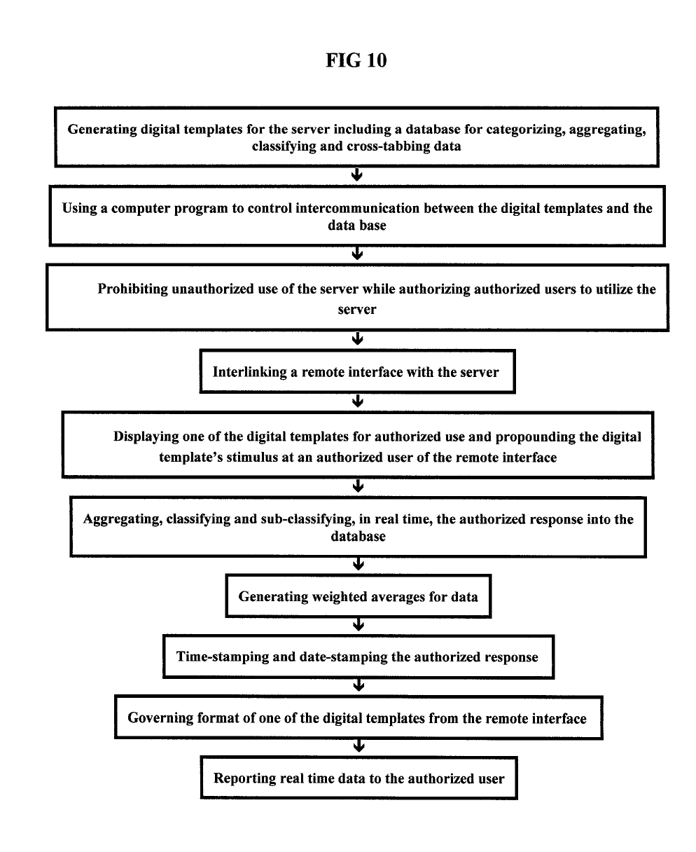

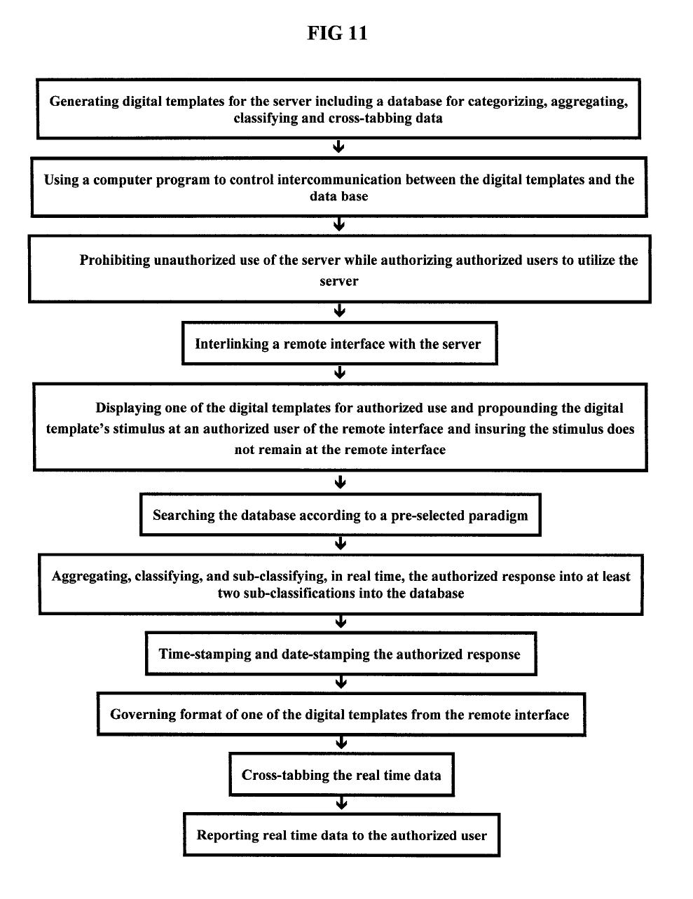

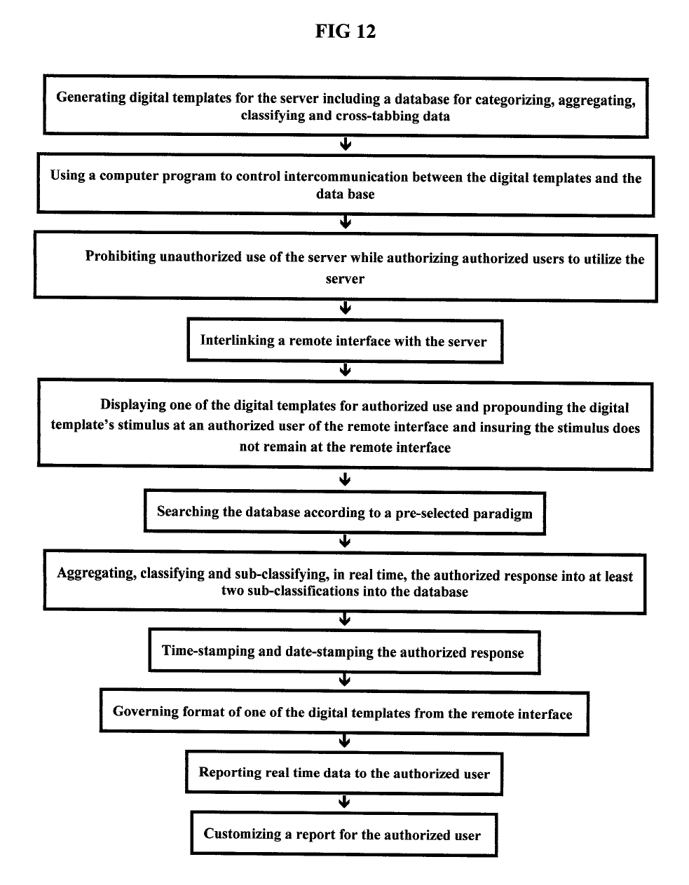

In yet another embodiment, the system administrator can cause the invention to create a customized report for an authorized user. In other words, database (90) and server memory (32) can be configured by computer program (94) to collate data in accordance with any authorized governor's preselected paradigm. For illustrative purposes, steps of the methodology of the present invention are set forth in FIGS. 6-12 while Specimen 8 presented below represents another exemplification of an administratively predetermined paradigm for a template that propounds stimuli at an authorized user.

As shown by Specimen 8's depiction of a template that could be displayed on the video display of an interface remote from the server, the authorized user's responses are accordingly classified and sub-classified, in real time. Question types can include yes/no, range or Likert scale. As displayed, the “Key Name” field includes a unique key word that identifies a specific survey template, i.e., by store, district, region, etc., while the “Always Display” field differentiates questions that are always displayed at a first level on the template from “pop-up questions” displayed on the template subsequent to an authorized user's response.

Survey Sections/Questions:

| | | Question | Key | Always |
|---|---|---|---|---|
| Section | Question | Type | Name | Display |
| Host/Hostess | Were you greeted | Yes/No | Yes/No | Yes |
| | promptly by our | | | |
| | Host/Hostess? | | | |
| | Did the Host/ | Yes/No | YesNo | Yes |
| | Hostess greet you | | | |
| | in a friendly | | | |
| | manner? | | | |
| | Were you seated | Yes/No | YesNo | Yes |
| | in the time frame | | | |
| | the Host/Hostess | | | |
| | told you would | | | |
| | be? | | | |
| | How satisfied | Select Range | Satisfaction | Yes |
| | overall were you | | | |
| | with your experi- | | | |
| | ence from the | | | |
| | time you entered | | | |
| | the restaurant | | | |
| | until you were | | | |
| | seated? | | | |
| Food Quality | Was your food | Yes/No | YesNo | Yes |
| | served hot? | | | |
| | Was your food | Yes/No | YesNo | Yes |
| | served as you | | | |
| | ordered it | | | |
| | (including any | | | |
| | special requests)? | | | |
| | How satisfied | Select Range | Satisfaction | Yes |
| | were you with the | | | |
| | overall quality | | | |
| | of your food? | | | |
| Atmosphere | Was one of the | Yes/No | YesNo | Yes |
| | primary reasons | | | |
| | for dining at | | | |
| | this restaurant | | | |
| | it's atmosphere? | | | |
| | On a scale of 1 to | Select Range | Numeric | Yes |
| | 5, with 1 being | | | |
| | “Not at all” and | | | |
| | 5 being “Exactly” | | | |
| | rate the | | | |
| | atmosphere of | | | |
| | this restaurant | | | |
| | compared to what | | | |
| | you expected: | | | |
| | How satisfied | Select Range | Satisfaction | Yes |
| | overall were you | | | |
| | with the atmos- | | | |
| | phere of this | | | |
| | restaurant? | | | |
| Overall Dining | How satisfied | Select Range | Satisfaction | Yes |
| Experience | were you with | | | |
| | your overall | | | |
| | dining experi- | | | |
| | ence at this | | | |
| | restaurant? | | | |
| | On a scale of 1 to | Select Range | Numeric | Yes |
| | 5, with 1 being | | | |
| | “Not Very” and | | | |
| | 5 being “Very” | | | |
| | how likely are | | | |
| | you to dine at | | | |
| | this restaurant | | | |
| | again? | | | |
| | Did this dining | Yes/No | YesNo | Yes |
| | experience have | | | |
| | a direct effect | | | |
| | on the response | | | |
| | you gave in | | | |
| | the previous | | | |
| | question? | | | |
| | Do you have any | Long User | Numeric | Yes |
| | additional | Response | | |
| | comments? | | | |

Having disclosed the invention as required by Title 35 of the United States Code, Applicants now pray respectfully that Letters Patent be granted for their invention in accordance with the scope of the claims appended hereto.

What is claimed is:

1) An end user friendly method of categorizing, aggregating, classifying, and reporting data, in real time, incorporating a server and an interface remote from said server, comprising the steps of:
a) generating a digital template for said server, wherein said server further includes a database for categorizing, aggregating and classifying said data;
b) controlling intercommunication between said digital template and said database via a computer program;
c) prohibiting unauthorized use of said server;
d) authorizing use of said server by an authorized user;
e) interlinking said remote interface with said server, wherein said computer program further interrelates said remote interface, said server and said digital template;
f) displaying said digital template for use by said authorized user;
g) propounding a stimulus from said digital template at an authorized user using said remote interface;
h) categorizing and aggregating continuously, in real time, an authorized response into said database;
i) classifying and sub-classifying continuously, pursuant to an administratively predetermined paradigm, said authorized response into said database;
j) time-stamping and date-stamping said authorized response; and
k) governing format of said digital template, by an authorized user from said remote interface.

2) The method of claim 1 further comprising the step of reporting said categorized, aggregated and classified data at said remote interface.

3) The method of claim 2 further comprising the step of cross-tabbing said data.

4) The method of claim 3 further comprising the step of searching said database according to a pre-selected paradigm.

5) The method of claim 4 further comprising the step of generating weighted averages.

6) The method of claim 5 further comprising the step of insuring said stimulus is not retained at said remote interface.

7) The method of claim 6 further comprising the step of said authorized user purchasing an authorized access to said server.

8) The method of claim 7 further comprising the step of originating a report customized for said authorized user.

9) An end user friendly method of categorizing, aggregating, classifying and reporting data, in real time, incorporating a server and an interface remote from said server, comprising the steps of:
a) generating a plurality of digital templates for said server, wherein said server further includes a database for categorizing, aggregating and classifying said plurality of digital templates and said data;
b) controlling intercommunication between said plurality of digital templates and said database via a computer program;
c) prohibiting unauthorized use of said server;
d) authorizing use of said server by an authorized user;
e) interlinking said remote interface with said server, wherein said computer program further interrelates said remote interface, said server and said plurality of digital templates;
f) displaying at least one of said plurality of digital templates for use by said authorized user;
g) propounding a stimulus from at least one of said plurality of said digital templates at an authorized user using said remote interface;
h) categorizing and aggregating continuously, in real time, an authorized response into said database;
i) classifying and sub-classifying continuously, pursuant to an administratively predetermined paradigm, said authorized response into said database;
j) time-stamping and date-stamping said authorized response;
k) governing format of at least one of said plurality of digital templates from said remote interface; and
l) reporting real time data to said authorized user.

9) The method of claim 8 further comprising the step of cross-tabbing said data.

10) The method of claim 9 further comprising the step of generating weighted averages.

11) The method of claim 10 further comprising the steps of categorizing and classifying said authorized response into at least two sub-classifications.

12) The method of claim 11 further comprising the step of searching said database according to a pre-selected paradigm.

13) The method of claim 12 further comprising the step of insuring said stimulus is not retained at said remote interface.

14) The method of claim 13 further comprising the step of originating a report customized for said authorized user.

15) An end user friendly method of categorizing, aggregating, classifying and reporting data, in real time, incorporating a server and an interface remote from said server, comprising the steps of:
a) generating a plurality of digital templates for said server, wherein said server further includes a database for categorizing, aggregating and classifying said plurality of digital templates and said data;
b) controlling intercommunication between said plurality of digital templates and said database via a computer program;
c) prohibiting unauthorized use of said server;
d) authorizing use of said server by an authorized user;
e) interlinking said remote interface with said server, wherein said computer program further interrelates said remote interface, said server and said plurality of digital templates;
f) displaying at least one of said plurality of digital templates for use by said authorized user;
g) propounding a stimulus from at least one of said plurality of said digital templates at an authorized user using said remote interface;
h) insuring said stimulus is not retained at said remote interface;
i) categorizing and aggregating continuously, in real time, an authorized response into said database;
j) classifying and sub-classifying continuously, pursuant to an administratively predetermined paradigm, said authorized response into at least two sub-classifications;
k) time-stamping and date-stamping said authorized response;
l) governing format of at least one of said plurality of digital templates from said remote interface;
m) generating weighted averages; and
m) reporting real time data to said authorized user.

16) The method of claim 15 further comprising the step of cross-tabbing said data.

17) The method of claim 16 further comprising the step of searching said database according to a pre-selected paradigm.

18) The method of claim 17 further comprising the step of reporting more than one pre-selected category of real time data.

19) An end user friendly method of categorizing, aggregating, classifying and reporting data, in real time, incorporating a server and an interface remote from said server, comprising the steps of:
a) generating a plurality of digital templates for said server, wherein said server further includes a database for categorizing, aggregating and classifying said plurality of digital templates and said data;
b) controlling intercommunication between said plurality of digital templates and said database via a computer program;
c) prohibiting unauthorized use of said server;
d) authorizing use of said server by an authorized user;
e) wireless interlinking said remote interface with said server, wherein said computer program further interrelates said remote interface, said server and said plurality of digital templates;
f) displaying at least one of said plurality of digital templates for use by said authorized user;
g) propounding a stimulus from at least one of said plurality of said digital templates at an authorized user using said remote interface;
h) insuring said stimulus is not retained at said remote interface;
i) categorizing and aggregating continuously, in real time, an authorized response into said database;
j) classifying and sub-classifying continuously, pursuant to an administratively predetermined paradigm, said authorized response into at least two sub-classifications;
k) time-stamping and date-stamping said authorized response;
l) governing format of at least one of said plurality of digital templates from said remote interface;
m) generating weighted averages; and
m) reporting at least one pre-selected category of real time data to said authorized user.

20) The method of claim 15 further comprising the step of cross-tabbing said data.

21) The method of claim 16 further comprising the step of searching said database according to a pre-selected paradigm.
